(19) United States
(12) Patent Application Publication
(10) Pub. No.: US 2014/0195268 A1
(43) Pub. Date: Jul. 10, 2014

(54) MEDICAL MANAGEMENT SERVER AND MEDICAL MANAGEMENT METHOD THEREOF

(71) Applicant: Electronics and Telecommunications Research Institute, Daejeon (KR)

(72) Inventors: Joon-Ho LIM, Daejeon (KR); Chan Yong PARK, Daejeon (KR); Soo Jun PARK, Seoul (KR)

(21) Appl. No.: 13/918,613

(22) Filed: Jun. 14, 2013

(30) Foreign Application Priority Data
Jan. 9, 2013 (KR) 10-2013-0002515

(51) Int. Cl. G06F 19/00

(52) U.S. Cl. CPC G06F 19/3487
USPC 705/3

(57) ABSTRACT

According to the inventive concept, The health management server in accordance with the inventive concept includes an interface unit receiving progression data representing a health state of a user who got diagnosis or treatment in a hospital from a user terminal; and a statistical analysis unit statistically analyzing the progression data on the basis of clinical data representing a diagnosis record or a treatment record in the hospital and generating disease progressing information of the user according to the analysis result to provide the disease progressing information as result data. The interface unit collects the progression data through the user terminal on the basis of a collection policy for determining the progression data and transmits or displays the result data to the outside in response to a result request.

### CROSS-REFERENCE TO RELATED APPLICATIONS

This U.S. non-provisional patent application claims priority under 35 U.S.C. §119 of Korean Patent Application No. 10-2013-0002515, filed on Jan. 9, 2013, the entire contents of which are hereby incorporated by reference.

### BACKGROUND

The present inventive concept herein relates to a medical management server, and more particularly, to a medical management server analyzing disease progression of a patient who got treatment or diagnosis in the hospital to provide statistical information for disease management of a patient and a medical management method thereof.

As an electronic communication industry develops, attempts to use an electronic communication technology in a disease treatment and a disease management of a patient is being increased. For example, there is a remote medical management system collecting health information of a patient outside the hospital to send a warning message to the patient or advise a proper treatment to the patient.

However, a conventional remote medical management system sends a warning message through a simple medical analysis. For instance, the conventional remote medical management system sends a warning message only when a patient says there is a risk element according to a medical examination table or measured health information exceeds the predetermined numerical value. Thus, to complexly analyze various symptoms and health information of a patient, the patient had to go to the hospital and get a diagnosis of a doctor.

There are a lot of difficulties to totally and efficiently manage disease of a patient.

### SUMMARY

Embodiments of the inventive concept provide a medical management server. The medical management server may include an interface unit receiving progression data representing a health state of a user who got diagnosis or treatment in a hospital from a user terminal; and a statistical analysis unit statistically analyzing the progression data on the basis of clinical data representing a diagnosis record or a treatment record in the hospital and generating disease progressing information of the user according to the analysis result to provide the disease progressing information as result data. The interface unit collects the progression data through the user terminal on the basis of a collection policy for determining the progression data and transmits or displays the result data to the outside in response to a result request.

Embodiments of the inventive concept also provide a medical management method of a medical management server. The medical management method of a medical management server may include collecting progression data representing a health state of a user who got diagnosis or treatment in a hospital; determining a statistical analysis method with reference to at least one selection variable and performing a statistical analysis on the progression data according to clinical data representing a diagnosis record and a treatment record in the hospital; and generating disease progressing information of the user according to the statistical analysis result in response to a result request to provide the disease progressing information as result data.

### BRIEF DESCRIPTION OF THE FIGURES

Preferred embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout.

FIG. 1 is a block diagram illustrating a medical management system including a medical management server in accordance with example embodiments of the inventive concept.

FIG. 2 is a drawing illustrating a specific constitution of the medical management server illustrated in FIG. 1.

FIGS. 3 and 4 are drawings illustrating medical examination tables in accordance with example embodiments of the inventive concept.

FIGS. 5 and 6 are graphs illustrating statistical analysis results in accordance with example embodiments of the inventive concept.

FIG. 7 is a block diagram illustrating a constitution of a user terminal that communicates with the medical management server in accordance with example embodiments of the inventive concept.

FIG. 8 is a flow chart illustrating a medical management method in accordance with example embodiments of the inventive concept.

### DETAILED DESCRIPTION OF THE EMBODIMENTS

Embodiments of inventive concepts will be described more fully hereinafter with reference to the accompanying drawings, in which embodiments of the invention are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

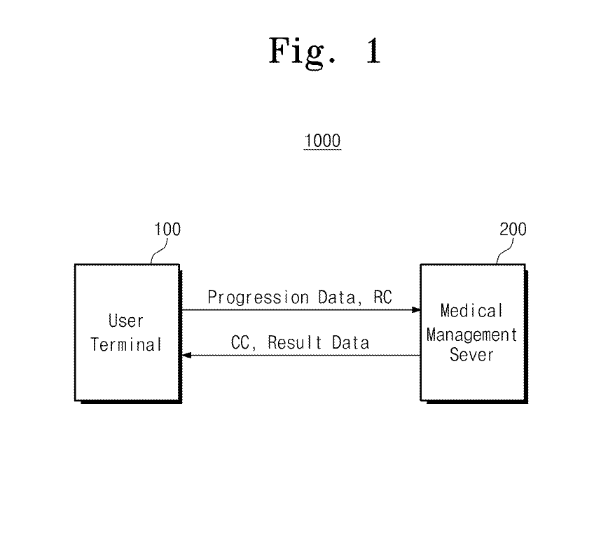

FIG. 1 is a block diagram illustrating a medical management system including a medical management server in accordance with example embodiments of the inventive concept. Referring to FIG. 1, the medical management system 1000 includes a user terminal 100 and a medical management server 200.

The user terminal 100 collects progression data from a user to provide the collected progression data to the medical management server 200. The progression data means data that represents a health condition of a user who got diagnosis or treatment in the hospital. The progression data may include health data such as a blood pressure, a body temperature, a blood sugar or oxygen saturation. The progression data may include medical examination data representing response content of a patient with respect to a predetermined medical examination table. The progression data may include life data such as quantity of motion, medication dosage or meal portion.

The user terminal 100 can collect or provide progression data in response to a collection command CC of the medical management server 200. The progression data which the user terminal 100 provides in response to the collection command CC may vary depending on a collection policy of the medical management server 200.

The medical management server 200 statistically analyzes progression data received on the basis of clinical data representing a record that a patient got diagnosis or treatment in the hospital. The medical management server 200 may have a different statistical analysis method for analyzing progression data depending on a selection variable selected by a user. The medical management server 200 generates disease progressing information representing a disease progressing state of a user. The generated disease progressing information may be provided to the user terminal 100 as result data.

The medical management server 200 may provide result data to the user terminal 100 in response to a result request RC from the user terminal 100. The result request RC may include information about a selection variable selected by a user.

According to the constitution described above, the medical management server 200 statistically analyzes progressing data collected from a user to provide disease progressing information representing a disease progressing state of a user. Thus, a user can use disease progressing information as a reference material for one's disease treatment. A user can judge whether one's disease gets better or gets worse as compared with diseases of other patients with reference to the disease progressing information. A user can predict one's disease progressing direction with reference to the disease progressing information. A user can statistically predict effect of an independent factor such as medication dosage on one's disease with reference to the disease progressing information.

Other user may refer to the disease progressing information to select a proper treatment method. Other users can determine a doctor or a medical institution that can treat their diseases best with reference to disease progressing information of patients which got treatment by other doctors (or other medical incidents).

The disease progressing information may be referenced by a doctor or a medical incident to be used as a reference material for a disease progression analysis or a disease progression study.

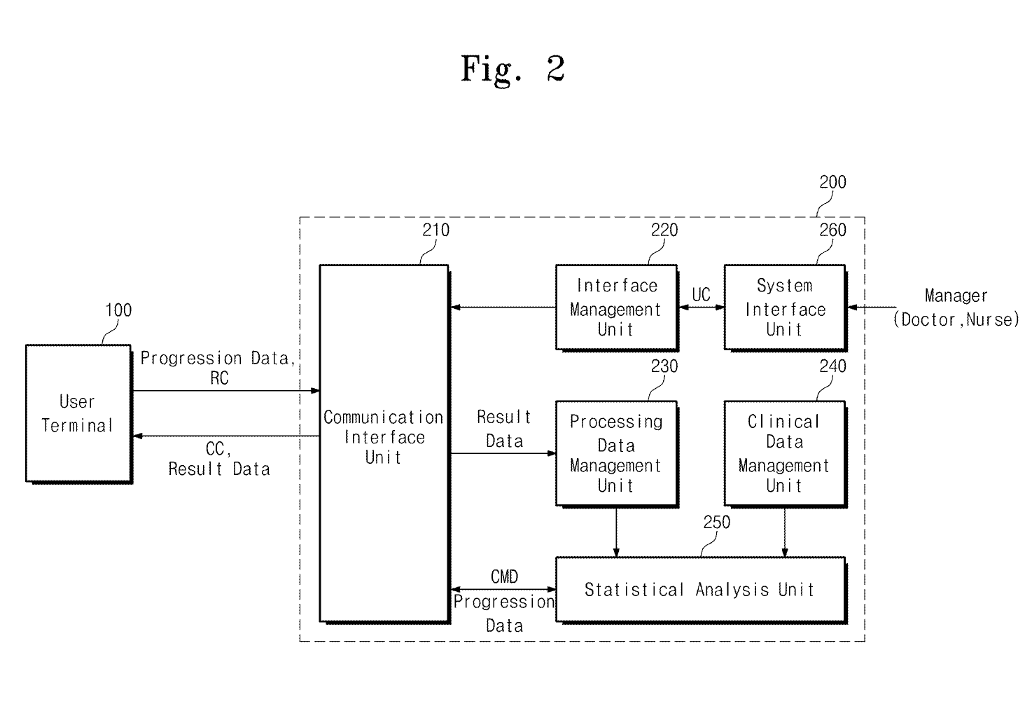

FIG. 2 is a drawing illustrating a specific constitution of the medical management server illustrated in FIG. 1. Referring to FIG. 2, the medical management server 200 includes a communication interface unit 210, an interface management unit 220, a progression data management unit 230, a clinical data management unit 240, a statistical analysis unit 250 and a system interface unit 260.

The communication interface unit 210 transmits a collection command CC to the user terminal 100 according to a collection policy. The communication interface unit 210 receives progression data being provided in response to the collection command CC to provide the received progression data to the progression data management unit 230. The communication interface unit 210 selects a part of data being transmitted from the user terminal 100 as progression data according to a collection policy and provides the selected progression data to the progression data management unit 230. The collection policy means a policy for determining data being collected by the user terminal 100 as progression data. The collection policy means a policy for selecting a part of data being transmitted from the user terminal 100 as progression data.

The progression data may include health data such as a blood pressure, a body temperature, a blood sugar or oxygen saturation measured by a health measurement device. The progression data may include medical examination data representing response content of a user with respect to a predetermined medical examination table. The progression data may include life data such as quantity of motion, medication dosage or meal portion.

The communication interface unit 210 can transmit result data generated by the statistical analysis unit 250 to the user terminal 100. In response to the result request RC from the user terminal 100, the communication interface unit 210 may receive result data from the statistical analysis unit 250 to transmit the received result data to the user terminal 100.

The communication interface unit 210 may include a communication module for performing a data communication with the user terminal 100 through a wire or wireless network.

The interface management unit 220 stores a collection policy and controls the communication interface unit 210 so that the progression data is received according to the stored collection policy. The collection policy may include a type of data, a collection period or a collection target that will be collected as progression data.

The type of data means a specific item of data that will be collected. The type of data may include various data items such as a blood sugar, a body temperature, weight, a blood pressure, oxygen saturation, medication dosage, meal portion, quantity of motion, the type of medical examination table, etc. In the case that a blood sugar and a body temperature among health data of a user are collected as progression data, the type of data may include a blood sugar and a body temperature. In the case that medication dosage of a user among life data of a user is collected as progression data, the type of data may include medication dosage of a user.

The collection period means a time interval or a time period that the progression data is collected. In the case that a time period is ‘one hour’, the communication interface 210 collects progression data at every ‘one hour’. In the case that a collection period is ‘0’ or ‘immediately’, the communication interface 210 immediately collects the progression data.

The collection target means a user who will collect the progression data. That is, the collection target is used to select the user terminal 100 at which the progression data is collected among a plurality of user terminals. The collection target is used to select data received from a terminal of a specific user as the progression data among data received from a plurality of user terminals.

The collection target may include at least one selection condition for determining a user in which the progression data is collected. The collection target may include a target disease and a disease progression step as a selection condition. At this time, the communication interface unit 210 collects only data about a user corresponding with the target disease and the disease progression step.

The collection target may include information about an identification (ID) independently given to each of a plurality of users (or user terminals). The communication interface unit 210 collects the progression data from a user terminal corresponding to the identification (ID) selected according to a collection policy.

The interface management unit 220 can control the communication interface unit 210 to selectively receive or collect the progression data from the user terminal 100 according to a collection policy. By a control of the interface management unit 220, the communication interface unit 210 selectively receives or collects only data corresponding with the collection policy as the progression data. The collection policy can determine the type of data, a collection period and a collection target that will be received as the progression data. The progression data which is received or collected will be provided to the progression data management unit 230.

The interface management unit 220 can control the communication interface unit 210 to select or collect at least a part of data received from the user terminal 100 according to the collection policy as the progression data. By a control of the interface management unit 220, the communication interface unit 210 selects or collects data corresponding to the collection policy among the received data as the progression data. The progression data which is selected or collected will be provided to the progression data management unit 230.

The progression data management unit 230 stores or manages the progression data being provided from the communication interface unit 210. The progression data management unit 230 provides the stored progression data to the statistical analysis unit 250. The progression data management unit 230 can classify the progression data being provided into a plurality of categories according to the type of data to store or manage the classified categories. The progression data management unit 230 can classify a response to a medical examination item among the progression data into medical examination categories to store or manage the classified medical examination categories. The progression data management unit 230 can classify health data among the progression data into health categories to store or manage the classified health categories. The progression data management unit 230 can classify life data among the progression data into life categories to store or manage the classified life categories.

The progression data management unit 230 can store or manage the progression data being provided by user with reference to an identification independently given to a user.

The progression data management unit 230 can store or manage the progression data by user and category with reference to the type of data and identification.

The clinical data management unit 240 stores or manages clinical data representing a clinical record diagnosed or treated in a hospital. The clinical data may include the type of disease, a disease progression step, a diagnosis record of a patient or a treatment record of a patient that is diagnosed or treated in a hospital. The diagnosis record of a patient or the treatment record of a patient may include a method, a result and date of diagnosis or treatment, age, a body condition, health data, life data, etc. of targeted patient.

The clinical data management unit 240 provides clinical data stored for a statistical analysis about progression data to the statistical analysis unit 250.

The statistical analysis unit 250 performs a statistical analysis about the progression data with reference to a predetermined statistical analysis method and clinical data. The statistical analysis unit 250 may have different statistical analysis methods about the progression data depending on at least one selection variable being provided from a user or a manager. Information about the selection variable may be included in a result request RC being transmitted from the user terminal 100.

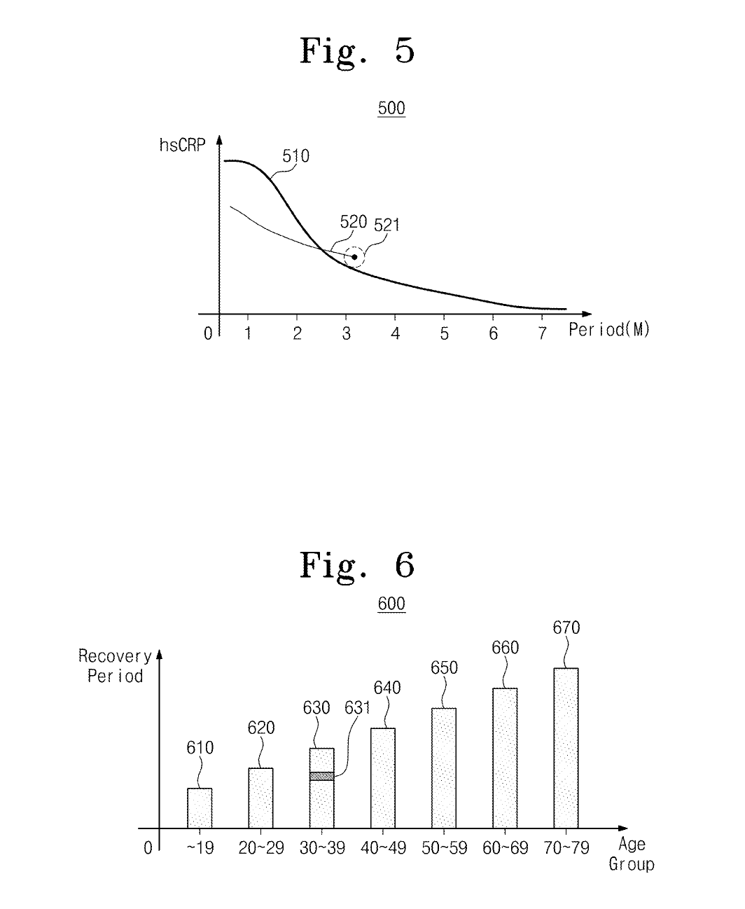

On the basis of the progression data and the clinical data, the statistical analysis unit 250 can statistically represent how the degree of disease progression and a recovery period of patients who got treatment or diagnosis in a hospital vary depending on the selection variable. Assume that the statistical analysis unit 250 performs a two dimensional analysis on a target disease. The statistical analysis unit 250 selects one independent variable and one dependent variable as selection variables among a plurality of predetermined variables. It is assumed that a treatment period of a patient is selected as the independent variable and a body index called HsCRP is selected as the dependent variable. The statistical analysis unit 250 can generate a HsCRP average value of the whole patient and a HsCRP average value of a user according to the treatment period as result data. With reference to the result data, a user can know whether one's HsCRP is high level or low level when viewed in the treatment period. Through a change of HsCRP average value of the whole patient according to the treatment period, a user can predict how one's HsCRP varies. A further detailed method that the statistical analysis unit 250 generates result data on the basis of progression data and clinical data will be described in FIGS. 5 and 6.

The statistical analysis unit 250 can provide the generated result data to the communication interface unit 210.

The system interface unit 260 controls the interface control unit 220 to generate or renew a collection policy. The system interface unit 260 receives an external command from a manager and controls the interface control unit 220 to generate or renew a collection policy according to the received external command. The manager who inputs the external command may be a doctor or a nurse.

According to the constitution described above, the medical management server 200 can statistically analyze progression data collected from a user to provide disease progressing information representing a disease progression status of a user. Thus, a user can use the disease progressing information as a reference material for one's disease treatment. With reference to the disease progressing information, a user can judge whether one's disease gets better or gets worse more rapidly as compared with other patients. With reference to the disease progressing information, a user can predict a progress direction of one's disease. With reference to the disease progressing information, a user can statistically predict the effect of an independent variable such as medication dosage on one's disease.

The disease progressing information may be used as a reference material so that other users select a proper treatment method. Other users can refer to disease progressing information of patients who got treatment by other doctors (other medical institutions) to determine a doctor or a medical institution that can treat their diseases best.

A doctor or a medical institution can refer to the disease progressing information to use it as a reference material for a disease analysis and a disease study.

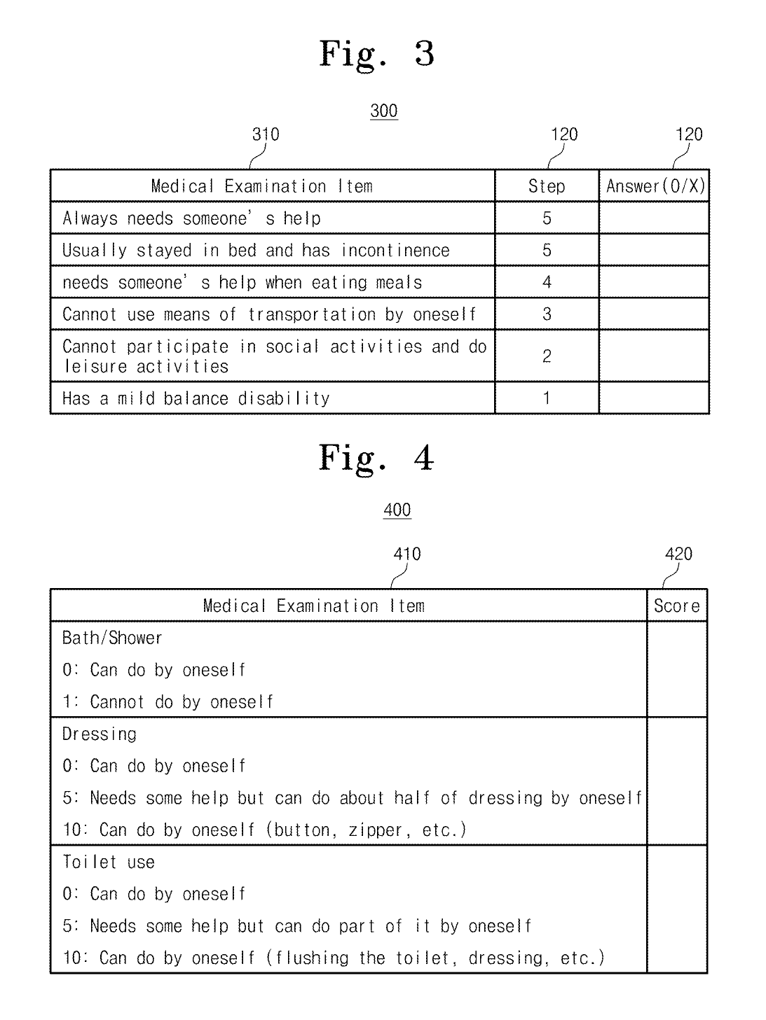

FIGS. 3 and 4 are drawings illustrating medical examination tables in accordance with example embodiments of the inventive concept. In FIGS. 3 and 4, a method of collecting progression data from a user through a medical examination table is expressed. In the case of using the medical examination table illustrated in FIGS. 3 and 4, an answer of a user to the medical examination table is collected as progression data.

FIG. 3 illustrates a medical examination table for measuring the degree of severity of a disease of a user. Referring to FIG. 3, a medical examination table 300 includes a medical examination item field 310, a step field 320 and an answer field 330. The medical examination table 300 in accordance with example embodiments of the inventive concept is mainly used to measure the degree of severity of a stroke patient.

The medical examination item field 310 represents an item for putting a question to a user. The step field 320 represents a step or the degree of severity of items written in the medical examination item field 310. The answer field 330 represents an answer of a user to each medical examination item.

In the medical examination table 300, the medical management system 1000 checks a step or the degree of severity of a medical examination item which is affirmatively (or ‘0’) answered with reference to an answer of a user to each medical examination item. And then, the medical management system 1000 determines the highest number among the checked steps or checked the degree of severity as a measurement result of the medical examination table 300. For example, it is assumed that answers of a user to an item that the user is always in need of help and an item that the user cannot use means of transportation alone are all affirmation. At this time, the medical management system 1000 determines the highest number 5 among corresponding steps or the degree of severity (5, 2) as a measurement result of the medical examination table 300. The determined measurement result is collected as progression data.

In FIG. 4, as another example of a medical examination table, a barthel index medical examination table is illustrated. The barthel index represents dependence on others when a patient performs a daily living activity. Referring to FIG. 4, a medical examination table 400 includes a medical examination item field 410 and a score field 420.

The medical examination item field 410 represents an item for putting a question to a user. The score field 420 represents an answer of a user to each medical examination item.

In the medical examination table 400, the medical management system 1000 calculates the sum of scores which are answered to each item with reference to an answer of a user to each medical examination item. The medical management system 1000 determines the sum of the calculated sum of scores as a measurement result of the medical examination table 400. The determined measurement result is collected as progression data.

FIGS. 5 and 6 are graphs illustrating statistical analysis results in accordance with example embodiments of the inventive concept. In FIGS. 5 and 6, examples of two-dimensional statistical analysis that analyzes one dependent variable according to one independent variable are illustrated as result data.

FIG. 5 shows the progress of disease of a user. FIG. 5 shows a HsCRP value relative to a treatment period of a target disease. Referring to FIG. 5, result data 500 includes a graph 510 (hereinafter it is referred to as an average value graph) showing a HsCRP average value relative to a treatment period of all patients and a graph 520 (hereinafter it is referred to as a user graph) showing a HsCRP measurement value relative to a treatment period of a user.

The average value graph 510 represents an average value of HsCRP of all patients relative to a treatment period. Referring to the average value graph 510, as the treatment period increases, the average value of HsCRP of all patients is reduced and when the treatment period becomes one month through three months, the average value of HsCRP of all patients is most rapidly reduced.

The user graph 520 represents a HsCRP value of a user measured according to a treatment period of the user. Referring to the user graph 520, as the treatment period increases, the HsCRP value of a user is reduced but as the treatment period increases, the degree of reduction is continuously is decreased. When comparing with the degree of HsCRP value reduction of all patients through the average graph 510, the degree of HsCRP value reduction of a user is definitely small while the treatment period becomes one month through three months. A HsCRP value of a user is lower than an average HsCRP value of all patients at the beginning of treatment period but a HsCRP value 521 of a user in the present is higher than an average HsCRP value of all patients.

Referring to the result data 500, a user can judge whether a user's HsCRP value according to a treatment period is higher or lower than that of a general case. A user can use the judgment as a reference material to maintain or change the user's current treatment method. A user can predict how a user's HsCRP value is changed according to an increase of treatment period with reference to the average value graph 510 and the user graph 520 of the result data 500.

In the present embodiment, the result data 500 is expressed as a curve graph but this is only an illustration and the inventive concept is not limited thereto. The result data 500 may be expressed by different kinds of graphs such as a bar graph, a circular graph, etc. The result data 500 can be expressed by numerical data which digitized a statistical analysis result. That is, the result data 500 can be expressed by various methods besides the method described above.

FIG. 6 is another example illustrating a recovery period of a user and a recovery period according to an age group of a target patient is illustrated in FIG. 6. Referring to FIG. 6, a result data 600 includes average recovery period graphs 610, 620, 630, 640, 650, 660 and 670 according to an age group of all patients and a recovery period value 631 according to a user's age.

Referring to the average recovery period graphs 610, 620, 630, 640, 650, 660 and 670, as an age group of all patients increases, a recovery period is increased.

Referring to a recovery period value 631 according to an age of a user, we can see a relative length of a recovery period of a user. Referring to the result data 600, when viewed in an age group (30-39) to which a user belongs, we can see that a recovery period of the user is somewhat long.

Referring to the result data 600, a user can judge whether the user's recovery period is short or long in the same age group. A user can see a trend of an average recovery period according to an age group of patients. The judgment can be used to evaluate a treatment method, a doctor or a medical institution that treated the user.

In the present embodiment, the result data 600 is expressed by a bar graph but this is only an illustration and the inventive concept is not limited thereto. The result data 600 may be expressed by different kinds of graphs such as a curve graph, a circular graph, etc. The result data 600 can be expressed by numerical data which digitized a statistical analysis result. That is, the result data 600 can be expressed by various methods besides the method described above.

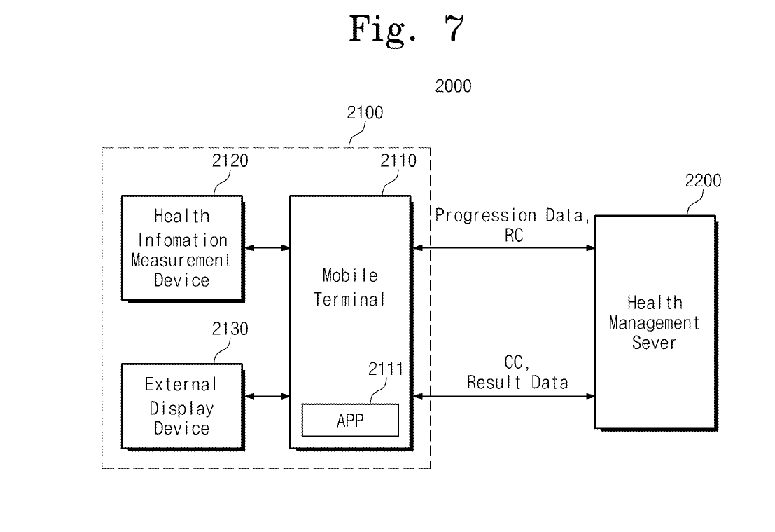

FIG. 7 is a block diagram illustrating a constitution of a user terminal that communicates with the medical management server in accordance with example embodiments of the inventive concept. Referring to FIG. 7, a medical management system 200 includes a user terminal 2100 and a medical management server 2200. The present embodiment is a thing that gives shape to the user terminal 100 illustrated in FIGS. 1 and 2. Thus, the rest constitution of the medical management system 1000 except a specific constitution of the user terminal 2100 is the same as that described in FIGS. 1 and 2. For example, a constitution and an operation of the medical management server 2200 are substantially the same as the constitution and the operation of the medical management server 200 illustrated in FIGS. 1 and 2.

Referring to FIG. 7, the user terminal 2100 includes a mobile terminal 2110 in which a medical management application 2111 is installed. The user terminal 2100 may further include a health information measurement device 2120 or an external display device 2130.

The mobile terminal 2110 includes a communication module for a wire or wireless communication with the medical management server 2200. The mobile terminal 2110 can transmit progression data to the medical management server 2200 through a medical management application 2111 or can receive result data from the medical management server 2200. For example, the mobile terminal 2110 can display a medical examination table being transmitted from the medical management server 2200 to a user and can receive an answer of a user to the displayed medical examination table to provide it as progression data. The mobile terminal 2110 can transmit a result request CC to the medical management server 2200 according to an operation of a user and can display result data being transmitted from the medical management server 2200 to a user.

The mobile terminal 2110 may include a smart phone or a tablet PC.

An identification may be given to the mobile terminal 2110 by the medical management server 2200.

The health information measurement device 2120 measures health data of a user to transmit the measured health data to the mobile terminal 2110. The health data provided to the mobile terminal 2110 may be provided to the health management server 2200 as progression data. The health information measurement device 2120 may include a weight scale, a blood pressure monitor, a blood sugar monitor or other measurement devices.

In response to a request from the mobile terminal 2110, the health information measurement device 2120 may measure health data of a user to transmit the measured health data to the mobile terminal 2110.

The external display device 2130 displays result data being transmitted from the mobile terminal 2110 to a user through a predetermined display means. The predetermined display means may be an alarm device generating a warning sound or a screen display device displaying result data.

According to the constitution described above, the medical management server 2200 may exchange data with the user terminal 2100 through the mobile terminal 2110 and may display result data to a user. The medical management server 2200 can receive health data of a user collected through the separate health information measurement device 2120. The medical management server 2200 may provide result data to the user terminal 2100 to make the result data displayed to a user through the external display device 2130.

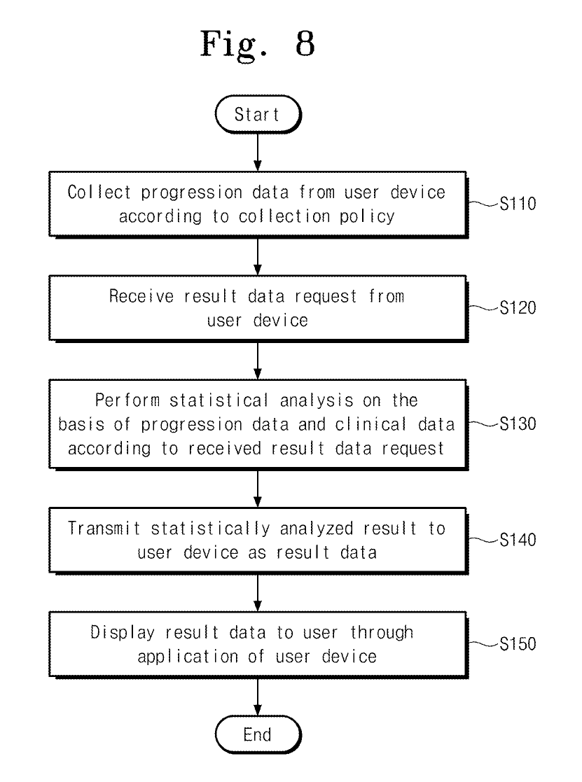

FIG. 8 is a flow chart illustrating a medical management method in accordance with example embodiments of the inventive concept. Referring to FIG. 8, the medical management method in accordance with example embodiments of the inventive concept includes steps S110 through S150.

In a step S110, the medical management server 200 (refer to FIG. 2) collects progression data from the user terminal 100 (refer to FIG. 2) according to a collection policy.

The user terminal 100 may collect progression data according to a collection policy to transmit the progression data to the medical management server 200 and the medical management server 200 may collect the received progression data to store the progression data in the progression data management unit 230 (refer to FIG. 2).

The medical management server 200 may collect progression data among data received from the user terminal 100 according to a collection policy to store the collected progression data in the progression data management unit 230.

The medical management server 200 can transmit a collection command CC (refer to FIG. 1) to the user terminal 100. The user terminal 100 can transmit data to the user terminal 100 in response to the collection command CC.

In a step S 120, the medical management server 200 receives a result request (or a result data request) from the user terminal 100. The result request RC (refer to FIG. 1) may include information about at least one selection variable selected by a user.

In a step S130, the medical management server 200 performs a statistical analysis on the basis of progression data and clinical data according to the received result request. The medical management server 200 can determine a statistical analysis method to be used in an analysis of the progression data with reference to at least one selection variable included in the result request RC. In the case that the selection variable is constituted by one independent variable and one dependent variable, the medical management server 200 can perform a two dimensional statistical analysis in response to the result request RC. If the independent variable is a treatment period and the dependent variable is a HsCRP variable, the medical management server 200 performs a statistical analysis representing a relation of a treatment period relative to a HsCRP like FIG. 5.

The medical management server 200 performs a statistical analysis in response to the received result request but the inventive concept is not limited thereto. If progression data is collected according to a collection policy, the medical management server 200 can perform a statistical analysis on the progression data using a predetermined statistical analysis method without a separate external command. The medical management server 200 can store a statistical analysis result, and then can output the stored statistical analysis result when a result request command from the outside is generated.

In a step S140, the medical management server 200 transmits the statistical analysis result to the user terminal 100 as result data. The medical management server 200 can transmit the result data to the user terminal 100 through a wire or wireless network. The medical management server 200 and the user terminal 100 can include a communication module (not shown) for a wire or wireless communication.

In a step S150, the user terminal 100 displays the transmitted result data to a user through an application of the user terminal 100. The user is a mobile terminal in which an application is installed and may include a smart phone or a tablet PC. The user terminal 100 can receive result data through the application installed in the mobile terminal and can transmit the received result data to an external display device connected to the mobile terminal The external display device displays the result data to a user on the basis of data transmitted from the mobile terminal. The external display device may include an alarm device generating a warning sound or a display device displaying a screen.

According to the constitution described above, the medical management service 200 can statistically analyze the progression data collected from a user to provide disease progressing information representing a disease progression state of a user. Thus, a user can use the disease progressing information as a reference material for a user's disease treatment. For example, a user can judge whether the user's disease gets better or gets worse more quickly as compared with that of other patient. A user can statistically predict a progressing direction of the user's disease with reference to the disease progressing information. A user can statistically predict an effect of an independent factor such as medication dosage on the user's disease with reference to the disease progressing information.

The disease progressing information may be referred by other user and other user can use the disease progressing information as a reference material for selecting a proper treatment method. Other user can determine a doctor or a medical institution that can treat the user best with reference to disease progressing information of patients who get treatment by different doctors (or medical institutions) respectively.

The disease progressing information is referred by a doctor or a medical institution to be used as a reference material for a disease progression analysis and a disease progression study.

According to the present inventive concept, a disease progression of a patient who gets diagnosis or treatment in a hospital is statistically analyzed to be provided to the patient.

A patient can effectively manage one's disease through a statistical analysis material about a disease from which a patient is suffering.

Since statistical information that analyzed a disease progression of a patient is provided, a doctor can use the statistical information as a reference material when the doctor treats or studies a corresponding disease.

The above-disclosed subject matter is to be considered illustrative, and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A medical management server comprising:
an interface unit receiving progression data representing a health state of a user who got diagnosis or treatment in a hospital from a user terminal; and
a statistical analysis unit statistically analyzing the progression data on the basis of clinical data representing a diagnosis record or a treatment record in the hospital and generating disease progressing information of the user according to the analysis result to provide the disease progressing information as result data,
wherein the interface unit collects the progression data through the user terminal on the basis of a collection policy for determining the progression data and transmits or displays the result data to the outside in response to a result request.

2. The medical management server of claim 1, further comprising:
an interface management unit storing and providing the collection policy; and
a system interface unit generating or renewing the collection policy according to an external command.

3. The medical management server of claim 2, wherein the collection policy comprises a type of data that will be collected as the progression data, a collection period of the progression data or a target in which the progression data is collected.

4. The medical management server of claim 1, further comprising:
a progression data management unit storing the progression data; and
a clinical data management unit storing the clinical data.

5. The medical management server of claim 4, wherein the progression data comprises a response of the user to a predetermined medical examination table, health data of the user or daily life data of the user.

6. The medical management server of claim 1, wherein the progression data management unit stores or manages the progression data depending on an independently given identification according to the user.

7. The medical management server of claim 1, wherein the statistical analysis unit uses a different method from the predetermined statistical analysis method with reference to information about at least one selection variable included in the result request.

8. The medical management server of claim 1, wherein a wire or wireless data communication with the user terminal is performed through a mobile terminal included in the user terminal

9. The medical management server of claim 8, wherein through a hospital application installed in the mobile terminal, the progression data is received from the user terminal or the result data is provided to the user terminal

10. The medical management server of claim 8, wherein health data of the user measured is received as the progression data through a health information measurement device included in the user terminal.

11. A medical management method of a medical management server comprising:
collecting progression data representing a health state of a user who got diagnosis or treatment in a hospital;
determining a statistical analysis method with reference to at least one selection variable and performing a statistical analysis on the progression data according to clinical data representing a diagnosis record and a treatment record in the hospital; and
generating disease progressing information of the user according to the statistical analysis result in response to a result request to provide the disease progressing information as result data.

12. The medical management method of claim 11, wherein collecting the progression data is performed on the basis of a collection policy for determining the progression data.

13. The medical management method of claim 11, wherein the progression data comprises a response of the user to a predetermined medical examination table, health data of the user or daily life data of the user.
